(19) United States
(12) Patent Application Publication
(10) Pub. No.: US 2014/0314358 A1
(43) Pub. Date: Oct. 23, 2014

(54) ROLLING-ELEMENT BEARING SUPPORT MODULE AND COMPRESSOR

(71) Applicants: Michel Seubert, Schweinfurt (DE); Ingo Schulz, Gerolzhofen (DE)

(72) Inventors: Michel Seubert, Schweinfurt (DE); Ingo Schulz, Gerolzhofen (DE)

(21) Appl. No.: 13/884,833

(22) PCT Filed: Nov. 3, 2011
(86) PCT No.: PCT/EP2011/069273

§ 371 Date: Jul. 19, 2013

(30) Foreign Application Priority Data
Nov. 12, 2010 (EP) 10 2010 043 807.3

(51) Int. Cl. F16C 19/54; F01C 21/02; F16C 35/077

(52) U.S. Cl. CPC F16C 19/545; F16C 19/541; F16C 35/077; F01C 21/02
USPC 384/454; 384/452

(57) ABSTRACT

A rolling-element bearing support module includes a support for mounting on an end wall of a machine. The machine has a bore in the end wall and a shaft in the bore, and the shaft has an abutment surface in a plane of the end wall. A rolling-element bearing assembly of the module includes a first bearing and a second bearing on the shaft, and a side surface of the first bearing is aligned with a plane corresponding to the end surface of the machine. The first bearing is formed to transmit, via the side surface, axial forces in at least one direction and the second bearing is disposed on a side of the first rolling-element bearing that faces away from the side surface of the first bearing.

Exemplary embodiments of the present invention relate to a rolling-element bearing support module for a machine, for example a compressor or a screw compressor, and a compressor.

In many machines, not only their basic functionality but also their efficiency depends on parameters which characterize the interaction of individual components with one another. These include, for example, the actually-produced dimensions, which are quite decisively influenced already during the design process by the corresponding definitions of tolerances. The same also applies to the position of individual components with respect to one another, which is significantly influenced already at a very early time point in the development phase of a machine, since the boundary conditions for the later component manufacturing and assembly are already defined in this phase. In machines having rotating parts, this places not-insignificant demands on the corresponding bearing, its attachment to the housing, or other components, as well as the associated shaft. The alignment of the relevant parts to one another is also often a significant factor.

In the case of screw compressors and other compressors, an end gap, for example, which is between a housing of such a compressor and one of the surfaces of a rotor, is important for the efficiency of such a compressor. However, other dimensions and positions of components with respect to one another also determine in part, in a not-insignificant manner, the performance, efficiency, and cost-effectiveness of machines having bearings that are to be positioned exactly, and corresponding abutment surfaces on their housing or on other components.

The object thus often arises to create a bearing assembly which makes possible a more precise alignment of a shaft to another component having an end surface.

This object is achieved by a rolling-element bearing support module according to claim 1 or a compressor according to claim 10.

For a machine, a rolling-element bearing support module according to an exemplary embodiment of the present invention thus comprises a support for mounting on the machine, wherein the machine has an end surface with a bore, into which a shaft having an abutment surface extending in the radial direction at least partially extends in the axial direction, wherein the end surface and the abutment surface extend substantially parallel to one another. The rolling-element bearing support module according to an exemplary embodiment of the present invention thus further comprises a rolling-element bearing assembly including a first rolling-element bearing and a second rolling-element bearing, which is disposed indirectly or directly adjacent to the first rolling-element bearing in the axial direction, wherein the rolling-element bearing assembly is formed to transmit, via the first rolling-element bearing, axial forces in at least one axial direction, but substantially no radial forces. The rolling-element bearing assembly is further formed to support, and to transmit to the support via the second rolling-element bearing, radial forces, but substantially no axial forces in the at least one axial direction, wherein a side surface of the first rolling-element bearing is aligned with one of the end surfaces of the machine or the plane corresponding to the abutment surface of the shaft. The first rolling-element bearing is further formed to transmit the axial forces in the at least one direction, via the side surface, to a component in a corresponding plane of the other surface of the end surface and of the abutment surface of the shaft. The second rolling-element bearing is disposed on a side of the first rolling-element bearing that faces away from the side surface of the first rolling-element bearing.

According to a further exemplary embodiment of the present invention, a compressor comprises a first component having a bore in an end surface of the first component, a shaft, which extends substantially in the axial direction parallel to the bore and into the bore, and an abutment surface, which extends substantially in the radial direction and substantially parallel to the end surface of the first component, and a rolling-element bearing assembly including a first rolling-element bearing and a second rolling-element bearing, which is disposed indirectly or directly adjacent in the axial direction to the first rolling-element bearing. The rolling-element bearing assembly is further formed here to support, via the first rolling-element bearing, axial forces in at least one axial direction, but substantially no radial forces. The rolling-element bearing assembly is further formed to support, and transmit to the first component, radial forces via the second rolling-element bearing, but substantially no axial forces in the at least one axial direction. A side surface of the first rolling-element bearing is in contact with the end surface or the abutment surface of the shaft. The first rolling-element bearing is formed to transmit the axial forces in the at least one direction, via the side surface, to the other surface of the end surface and of the abutment surface of the shaft. The second rolling-element bearing is disposed on a side of the first rolling-element bearing that faces away from the side surface of the first rolling-element bearing.

Exemplary embodiments of the present invention are thus based on the recognition that a tolerance chain can be shortened, in the case of a bearing assembly including at least two rolling-element bearings, by disposing the first rolling-element bearing, which supports the axial forces in at least one direction, on the shaft such that only the first rolling-element bearing contributes to the tolerance chain for the axial direction. In the case of the compressor, this is achieved in that the first rolling-element bearing is disposed on the shaft or on the first component such that the side surface of the first rolling-element bearing is directly in contact with the end surface of the first component or the abutment surface of the shaft, while the axial force is transmitted from the side surface of the first rolling-element bearing directly to the other surface on the associated component, i.e. the shaft or the first component.

Also in the case of the rolling-element bearing support module, this arrangement of the first rolling-element bearing of the rolling-element bearing assembly is chosen such that—after an installation—a suitable arrangement results.

In further developments of exemplary embodiments of the present invention, this can be realized for example in that the first rolling-element bearing is an angular contact ball bearing, which for example has a width tolerance of the class PA4 or PA7 or finer. The second rolling-element bearing can for example be formed by a cylindrical roller bearing. Likewise it is possible to provide one or more further angular contact ball bearings or radical bearings which are disposed in the rolling-element bearing assembly and for example can be found between the first and the second rolling-element bearing.

In the case of a rolling-element bearing support module according to an exemplary embodiment of the present invention, this can for example be connected to the machine by creating a materially-bonded or a friction-fit connection.

Exemplary embodiments of the present invention will be explained with reference to the following Figures.

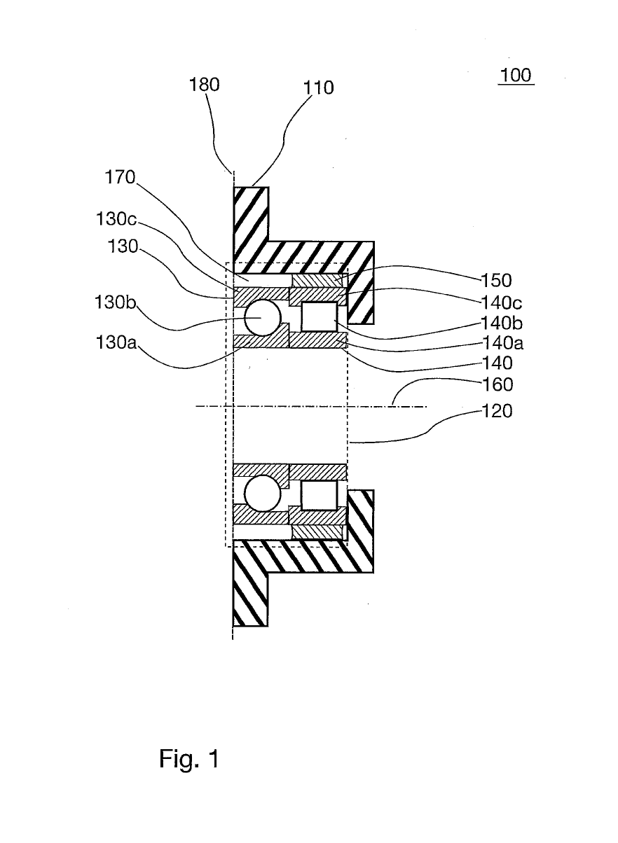

FIG. 1 shows a sectional view of an exemplary embodiment of a rolling-element bearing support module;

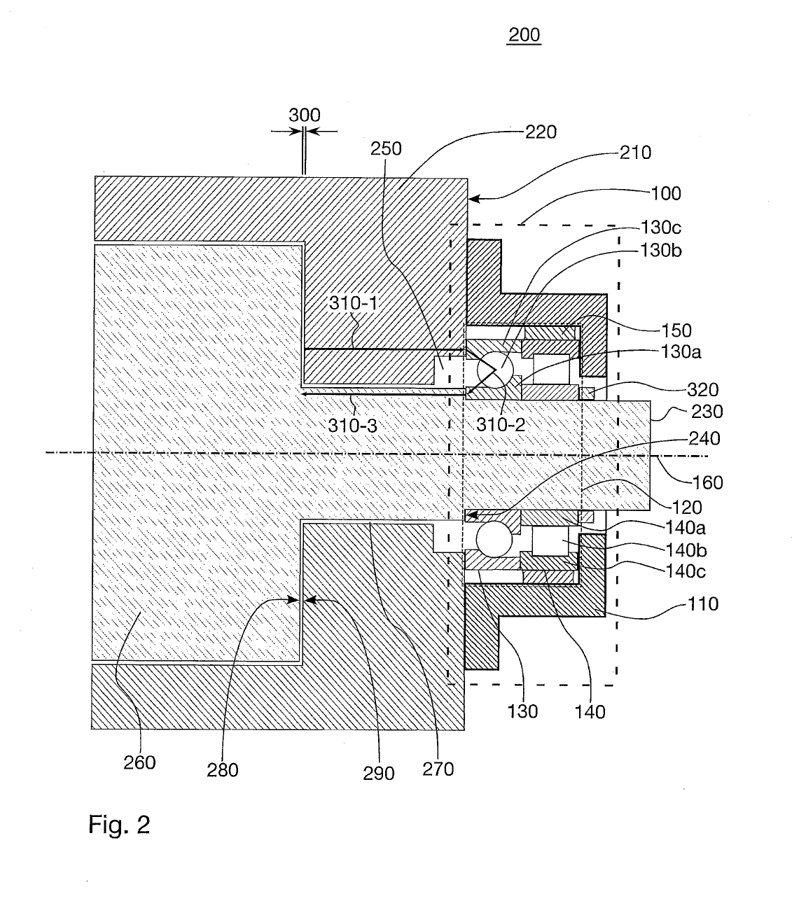

FIG. 2 shows a cross-sectional view of a compressor including a mounted rolling-element bearing support module according to exemplary embodiments of the present invention;

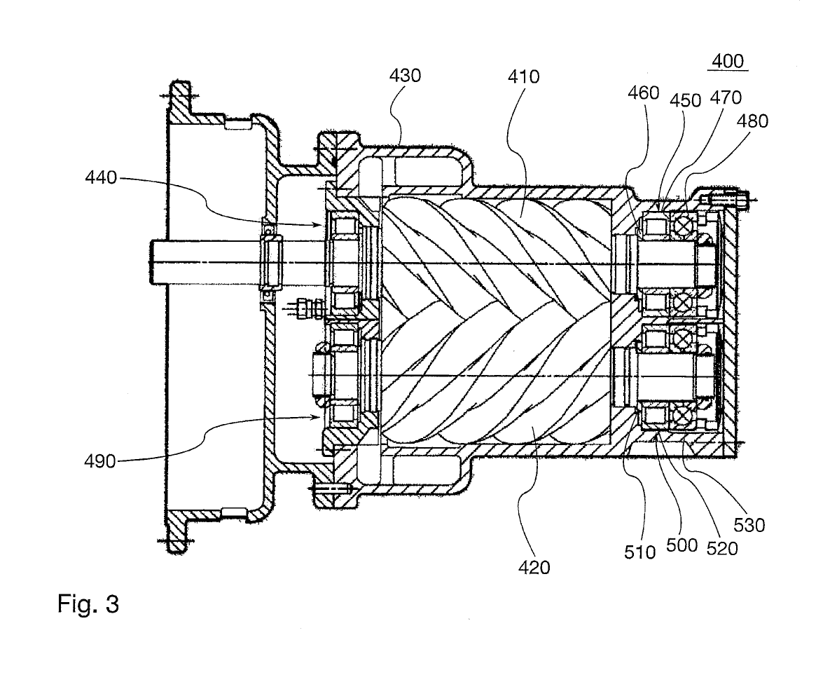

FIG. 3 shows a sectional view of a screw compressor;

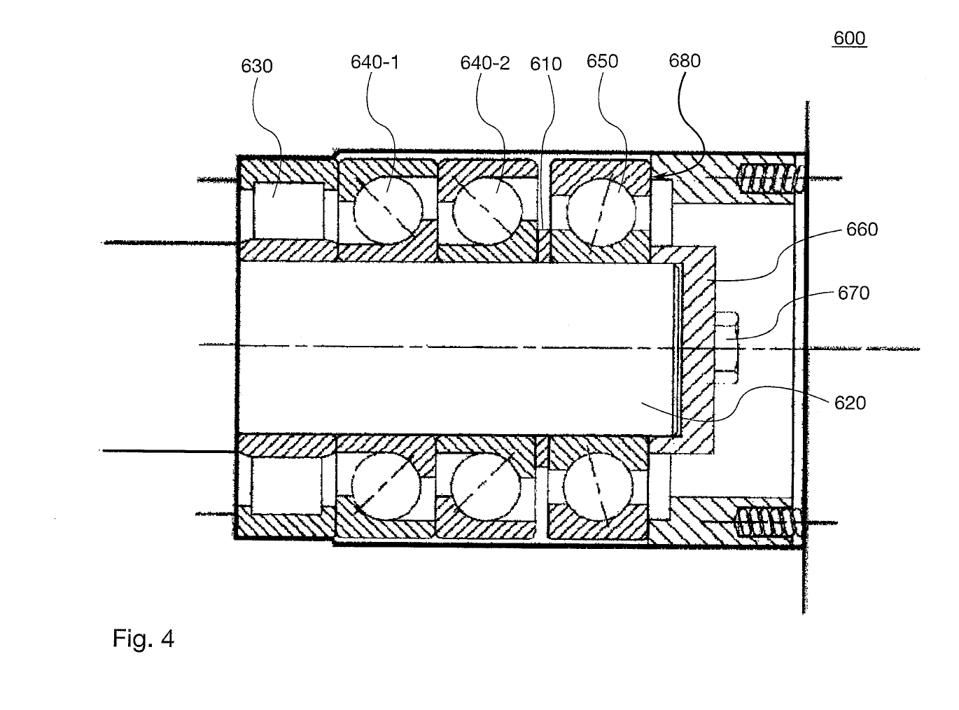

FIG. 4 shows a cross section of a conventional bearing assembly including a to-be-ground intermediate ring;

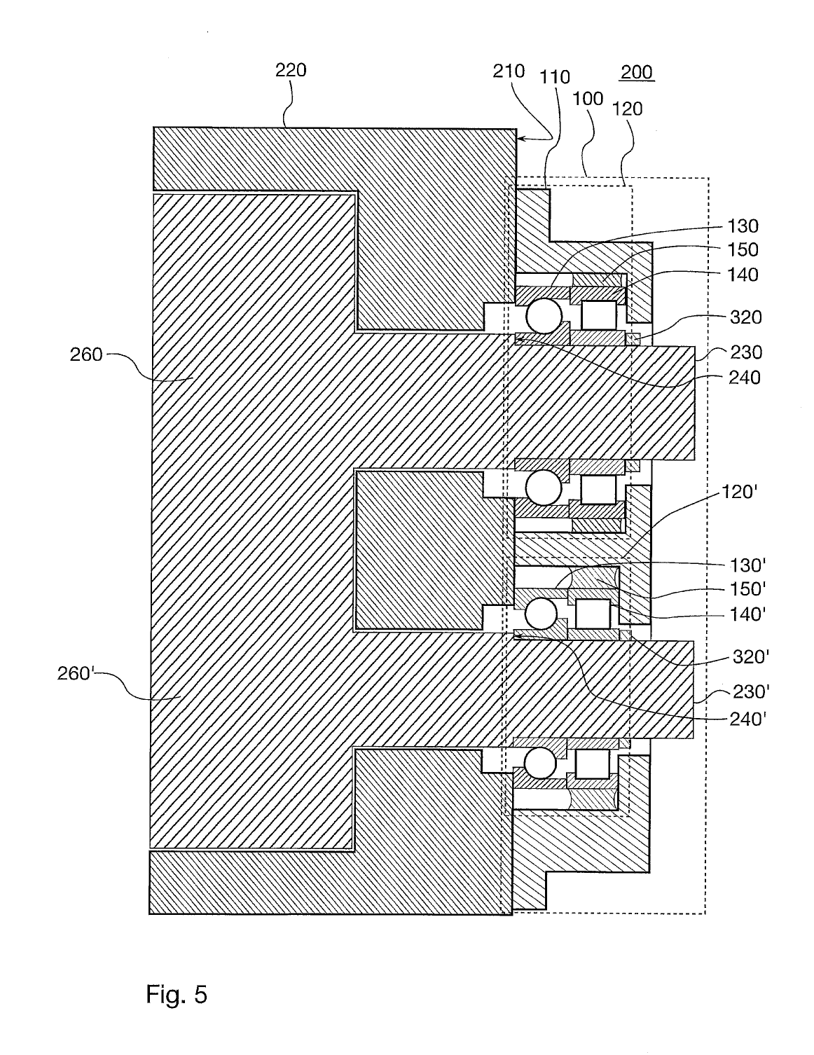

FIG. 5 shows a cross-sectional view of a compressor including a mounted rolling-element bearing support module according to exemplary embodiments of the present invention for 2 shafts;

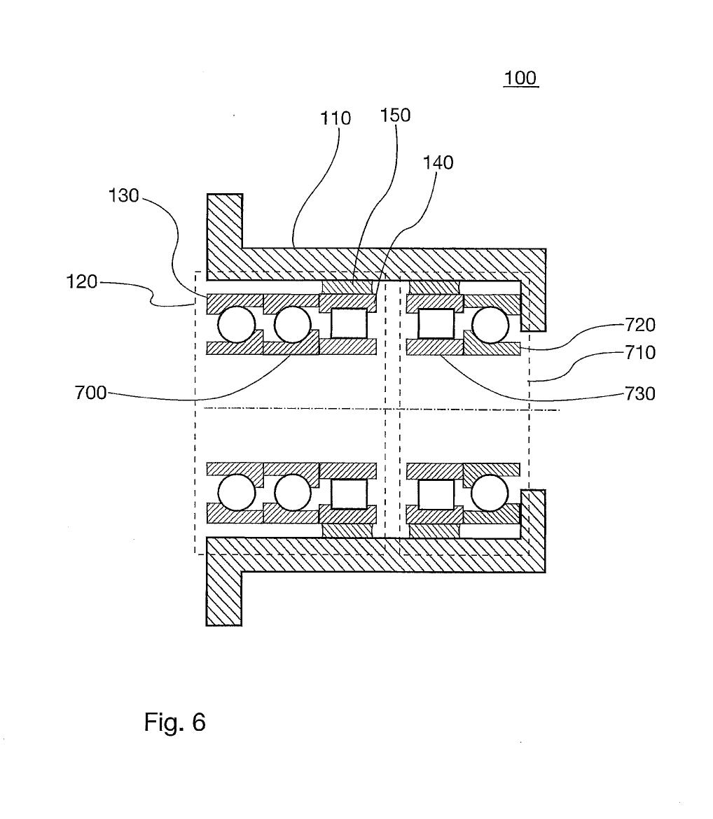

FIG. 6 shows a cross-sectional view of a rolling-element bearing support module according to an exemplary embodiment of the present invention for a locating/non-locating bearing arrangement; and

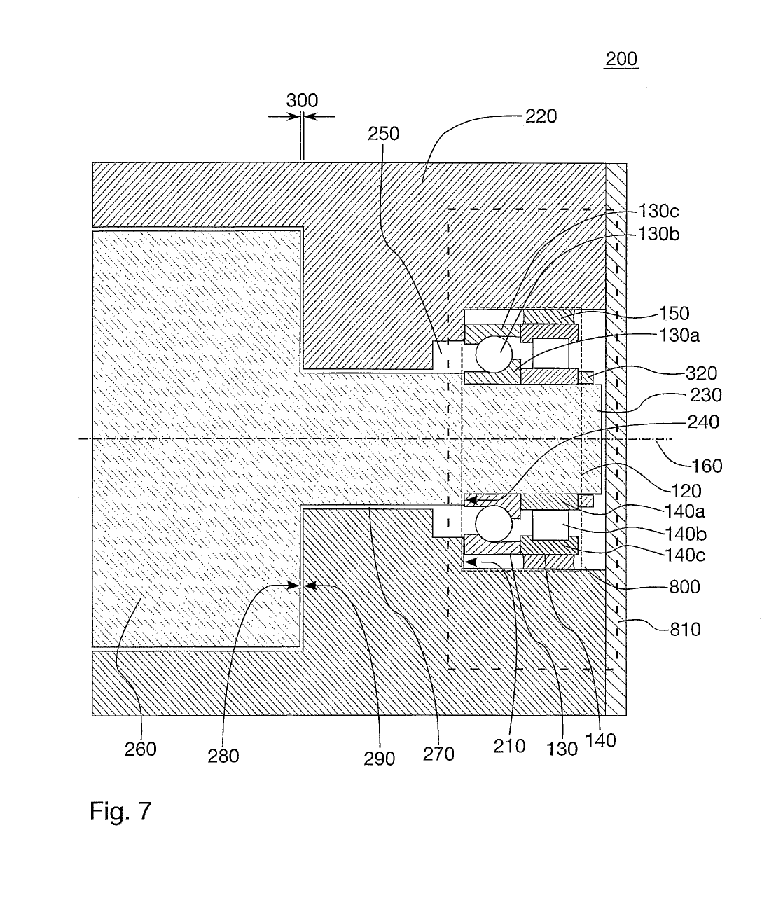

FIG. 7 shows a cross-sectional view of a compressor according to en exemplary embodiment of the present invention.

Before exemplary embodiments of the present invention and comparison structures will be described and explained with regard to their operation in the context of FIGS. 1-7, it should first be pointed out that, in the context of the present application, summarizing reference numbers are used for simplifying the description. Machine elements, components, component assemblies, and other elements, which are designated using summarizing reference numbers, can here be identically embodied and/or dimensioned. However, with regard to their dimensioning and design, they can also differ from one another in any constructively meaningful dimensions or be embodied differently.

FIG. 1 shows a rolling-element bearing support module 100 according to an exemplary embodiment of the present invention, including a support 110 and a rolling-element bearing assembly 120, which comprises a first rolling-element bearing 130 and a second rolling-element bearing 140. The rolling-element bearing assembly 120 further comprises a bearing casing 150 in the region of the second rolling-element bearing 140, which creates a mechanical connection in a radial direction between the support 110 and the second rolling-element bearing 140, via which mechanical connection radial forces are transferable from an inner ring 140a of the second rolling-element bearing via the rolling elements 140n and an outer ring 140c to the support 110.

However, the first rolling-element bearing 130 lacks a corresponding bearing casing. This results in a clearance 170 based upon a symmetry line 160, which symmetry line also represents a centerline of a shaft to be connected to the rolling-element bearing support module 100, which clearance 170 connects to the first rolling-element bearing 130 in the axial direction, so that at least 80% of a circumferential surface of an outer ring 130c of the first rolling-element bearing 130 is exposed. Depending on the specific design of a rolling-element bearing support module 100 according to an exemplary embodiment of the present invention, a structure can for example thus be contained in the clearance 170, which structure makes possible a fixing of the first rolling-element bearing 130 in the rolling-element bearing support module 100 for bearing and/or mounting purposes. With respect to the corresponding structure not shown in FIG. 1, it can for example be a multipart plastic honeycomb structure, which—after the attachment of the rolling-element bearing support module 100 on a shaft—is easily removable due to the multipart design.

In other exemplary embodiments of the present invention, it can however also optionally remain in the installed rolling-element bearing support module 100, provided it is ensured that substantially no radial forces can be transmitted through it to the support 110. This can be achieved by a choice of material, for example plastic, or by an appropriate geometric design, wherein at least 80% of the circumferential surface of the outer ring 130 of the first rolling-element bearing 130 is exposed. Optionally it can also be advisable to choose a higher proportion, approximately 90% or 95%, in order to the further reduce the degree of the force transmission. A transmission of radial forces to the support 110 via an inner ring 130a, the rolling elements 130b, and the outer ring 130c of the first rolling-element bearing can thereby be reduced so much that a corresponding radial force transmission substantially occurs only via the wide rolling-element bearing 140.

With regard to the alignment of the first and of the second rolling-element bearings 130, 140 in the axial direction, they are aligned in the exemplary embodiment shown in FIG. 1 such that a side surface of the first rolling-element bearing 130, which is formed by a side surface of the outer ring 130c of the first rolling-element bearing 130, is aligned with a plane 180, which also represents the plane of an end surface of the machine, for which the rolling-element bearing support module 100 is intended and designed. Moreover, in the exemplary embodiment shown in FIG. 1, the plane 180 matches the plane of the abutment surface of the shaft of the corresponding machine. However, in different exemplary embodiments of the present invention, a divergence of these two planes can be constructively intended.

The second bearing 140 connects in the axial direction to one of the above-described side surfaces of the second rolling-element bearing 140 opposite the side surface of the first rolling-element bearing. This can, however need not, be in direct contact with the first rolling-element bearing 130. Likewise there is little need that the second rolling-element bearing 140 be in direct contact in the axial direction with a surface of the support 110.

The rolling-element bearing support module 100, as it is shown in FIG. 1, here includes a universally pairable angular contact ball bearing as first rolling-element bearing 130, whose high shoulder on its outer ring 130c faces towards the plane 180. Accordingly the inner ring 130a does not have a large shoulder on the side facing away from the plane 180.

FIG. 1 here shows a separable or non-self-retaining angular contact ball bearing, so that both the outer ring 130c and the inner ring 130a have no shoulder on the side opposite the side having the high shoulder. Of course, in exemplary embodiments of the present invention angular contact ball bearings can also be used which are not separable, i.e. are designed as self-retaining, and thus have an appropriate lower shoulder on the side facing away from the side with the high shoulder.

In the rolling-element bearing support module 100 shown in FIG. 1, the second rolling-element bearing 140 is embodied as a cylindrical roller rolling-element bearing, wherein the outer ring 140c has flanges, while the inner ring 140a is embodied flange-free. In this way the rolling elements 140b can slide on the inner ring 140a along the axial direction, while they are retained by the flanges of the outer ring 140c. In this way the second rolling-element bearing 140 transmits, via the bearing casing 150, substantially only radial forces, but not axial.

FIG. 2 shows a compressor 200 according to an exemplary embodiment of the present invention, wherein the rolling-element bearing support module 100 shown in FIG. 1 and described there is mounted on an end surface 210 of a housing 220 of the compressor (housing end surface). The compressor 200 here represents an example of a machine on which support modules 100 can be used according to exemplary embodiments of the present invention.

The rolling-element bearing support module 100 is the same as the rolling-element bearing support module 100 shown in FIG. 1, which is why reference is made at this point to the description there. In contrast to the rolling-element bearing support module 100 shown in FIG. 1, the module 100 shown in FIG. 2 is connected not only to the end surface 210 of the compressor 200, but the rolling-element bearing assembly 120 is further mechanically coupled with a shaft 230. In the exemplary embodiment shown in FIG. 2, the respective inner rings 130a, 140a of the two rolling-element bearings 130, 140 are friction-fit connected to the shaft 230 by appropriate press-fits. The shaft 230 also has an abutment surface 240, wherein it is a shaft shoulder. The abutment surface 240 is here mechanically directly in contact with the inner ring 130a of the first rolling-element bearing 130, while a side surface of the outer ring 130c of the first rolling-element bearing 130 transmits an axial force, leftward in FIG. 2, of the shaft 230 via the balls 130b via the high shoulder of the outer ring 130c directly to the end surface 210 of the housing 220. In order to avoid a direct transmission of the force, leftward in FIG. 2, by the inner ring 130a in the axial direction onto the end surface 210, the housing 220 has an additional counterbore or clearance 250.

For the sake of completeness, at this point it lends itself to be noted that in the exemplary embodiment shown in FIG. 2, the planes, which are defined by end surface 210 and the abutment surface 240 of the shaft 230, are aligned with each other. However, this is not a requirement. It can optionally even be advisable in individual cases to offset these planes relative to each other.

The shaft 230 here is part of a rotor 260 and extends outwardly through a bore 270 of the housing beyond the end surface 210 of the housing 220. The rotor 260 here has a rotor end surface 280 which directly opposes a housing end surface 290 and forms an end gap 300 therebetween. Using the bearing assembly for screw compressors formed by the rolling-element bearing support module 100, it is now possible to adjust the end gap 300 between the rotor 260 and the housing 220 of the compressor 200 with a desired accuracy. This is effected by a shortening of the tolerance limit 310 responsible for the adjustment of the pressure-side end gap 300, which tolerance limit has three components 310-1, 310-2, and 310-3 in the example shown in FIG. 2. Since the end gap 300 is essential for the efficiency of the compressor 200, exemplary embodiments of the present invention can create the possibility to simplify the assembly process and make it more cost-effective, as will be explained below.

The first component 310-1 of the tolerance chain 310 results from the distance between the housing end side 290 in the interior of the housing 220 and the end face 210, onto which the rolling-element bearing support module 100 is affixed. The second component 310-2 results from the supporting of the shaft 230 mediated by the first bearing 130; it is therefore strongly dependent on the width tolerance of the first rolling-element bearing 130 or the tolerance of the outer ring 130c and of the inner ring 130a of the first rolling-element bearing 130. The third component 310-3 of the tolerance chain 310 is then substantially given by the tolerance of the distance from the abutment surface 240 to the rotor end surface 280.

In that the first rolling-element bearing 130 makes possible a direct friction fit between the end surface 210 and the abutment surface 240 of the shaft 230, the tolerance chain 310 can thus be significantly shortened in comparison to previous conventional solutions, so that either a smaller tolerance is achievable or the assembly process can be simplified. Of course, trade-off solutions can also be implemented.

In the solution described here, one or more universally pairable angular contact ball bearings 130 are axially brought into abutment on the compressor housing end side 210, and are radially held in the support module 100. In the exemplary embodiments shown in FIGS. 1 and 2, the universally pairable angular contact ball bearings 130 are chosen such that these can be provided with defined, narrow width tolerances, so that they enable a more exact adjustment of the end gap 300. Thus for example angular contact ball bearings with a width tolerance of class PA4 or PA7 or finer can be used in exemplary embodiments of the present invention. Depending on the specific application, it can also be advisable to use better or finer classes with regard to the width tolerance, i.e. for example the classes PA9A or P9. Other bearing types than the angular contact ball bearings shown here often have coarser width tolerances; thus they are not shown here in the description of exemplary embodiments of the present invention. Basically, however, they are also usable, provided they can be manufactured or obtained with appropriate width tolerances.

As FIG. 2 shows, the module 100 can be mounted and affixed as a unit together with its bearings 130, 140. As will be explained in even more detail in the context of FIG. 6, there is also the possibility, depending on the load, to additionally insert even more bearings in the support module 100.

The exemplary embodiment shown in FIG. 2 of a compressor 200 or of a rolling-element bearing support module 100 forgoes the use of to-be-ground intermediate rings, as will be explained below in the context of FIG. 3. Independent therefrom, in the context of the support module 100, the compressor 200 comprises a retaining ring 320, which is connected to the shaft 230 at a side surface of the inner ring 140a of the second rolling-element bearing 140 on the side facing away from the first rolling-element bearing 130. This ring 320 can for example be a shaft nut, an adhered ring, or a snap ring, which can be used for retaining and/or securing of the bearing assembly. In the exemplary embodiment shown in FIG. 2, the ring 320 can for example serve to secure the inner ring 140a of the second rolling-element bearing 140.

In the compressor 200 shown in FIG. 2, the rolling-element bearing support module 100 is connected in a friction-fit or materially-bonded manner to the end-side 210 of the housing 220. A friction-fit connection can for example be created by a suitable clamping of the rolling-element bearing support module 100. A materially-bonded connection can be created for example by adhesion, soldering, or welding.

As FIG. 2 has shown, in exemplary embodiments of the present invention it is possible to shorten the tolerance chain 310, which results due to an alignment of the abutment surface 240 of the shaft 230 and of the end surface 210.

FIG. 3 shows a cross-sectional view of a compressor 400 including a conventional bearing assembly, which comprises two to-be-ground intermediate rings. The compressor 400 here comprises two mechanically permanently coupled screw shafts 410, 420, of which the screw shaft 410 protrudes beyond a housing 430 of the compressor 400, and is capable of being driven by an external power source. In this case, the screw shaft 410 is supported in the housing 430 by a locating/non-locating bearing assembly. Thus the screw shaft 410 is guided on the drive-side via a non-locating bearing 440 in the form of a cylindrical roller bearing having flanges on the outer ring, however without flanges on the inner ring. The screw shaft 410 is supported in the housing 430 on the side facing away from the drive side via a locating bearing assembly 450. The rolling element bearing assembly 450 here comprises an intermediate ring 460, to which a cylindrical roller bearing 470 connects; the cylindrical roller bearing 470 has flanges exclusively on the outer ring, so that it transmits radial forces of the screw shaft 410 to the housing 430. On the side facing away from the intermediate ring 460, a four-point angular contact ball bearing 480 connects to the cylindrical roller bearing 470, which four-point angular contact ball bearing 480 has an undercut of the housing 430, so that axial forces are transmitted to the housing 430 exclusively via the outer ring of the four-point angular contact ball bearing 480 or via both outer rings of the four-point angular contact ball bearing 480 and the cylindrical roller bearing 470.

The second screw shaft 420 is also supported in the housing 430 with a corresponding locating/non-locating bearing. Thus the compressor 400 also includes a non-locating bearing 490 in the form of a cylindrical roller bearing on the drive side for the second screw shaft 420, which non-locating bearing 490 comprises flanges exclusively on the outer ring. Parallel to the locating bearing 450, the compressor also includes a locating bearing 500 for the second screw shaft 420 on the side facing away from the drive side, which locating bearing 500 also includes a to-be-ground intermediate ring 510, a cylindrical roller bearing 520, and a four-point angular contact ball bearing 530. These are constructed and disposed in correspondence with the intermediate ring 460, the cylindrical roller bearing 470, and the four-point angular contact ball bearing 480.

In the past, the cylindrical roller bearings 470, 520 responsible for supporting the radial forces (radial bearings) sit on the side of the rotor shafts 410, 420 facing towards the housing, so that the part of the tolerance chain of the components to be positioned axially is thus their inner- and outer rings. The adjustment of the axial position in this case takes place only after a trial installation and a corresponding measurement. After the first trial assembly of the pressure rating of the compressor 400 and after the measuring of the end gap, a component of the tolerance chain, i.e. for example a sleeve or one of the two intermediate rings 460, 510, is ground to the required dimension to adjust and balance the resulting tolerances, before the compressor 400 is then finally assembled a second time.

This complex double installation process, with measurement of the end gap and adjustment by grinding of an intermediate ring 460, 510 in the prior, conventional solution, can optionally be avoided with use of an exemplary embodiment of the present invention. A faster and more cost-effective assembly in one step is thus possible by the use of a compressor 200 according to an exemplary embodiment of the present invention or of a rolling-element bearing support module 100 according to an exemplary embodiment of the present invention, since a measurement of the end gap and a subsequent adjustment thereof by grinding an intermediate ring can optionally be omitted.

FIG. 4 shows a further example of a conventional bearing assembly 600 including a to-be-ground intermediate ring 610. A cylindrical roller bearing 630 is first disposed on the shaft 620 on the side facing towards the rotor, which cylindrical roller bearing 630 transmits the radial forces from the shaft 620 to the bearing assembly 600. The cylindrical roller bearing 630 again has flanges only on its outer ring, so that the cylindrical roller bearing 620 basically supports no axial forces. Two angular contact ball bearings 640-1, 640-2 connect directly to the cylindrical roller bearing 630 on the side facing away from the rotor, wherein each of the outer rings have high shoulders on the side facing towards the rotor, while their inner rings have corresponding high shoulders on the opposite side, i.e. on the side facing towards a shaft end. The bearing assembly 600 can thereby transmit axial forces in the direction of the motor to the bearing assembly or the housing of the compressor via the two angular contact ball bearings 640-1, 640-2 and the outer ring of the cylindrical roller bearing 630. Both angular contact ball bearings 640 are respectively undercut, so that radial forces are substantially not transmitted.

The previously mentioned intermediate ring 610 connects to the angular contact ball bearing 640-2, which intermediate ring 610 is disposed between the inner ring of the angular contact ball bearing 640-2 and an inner ring of a ball bearing 650. The thus-resulting assembly of the cylindrical roller bearing 630, the two angular contact ball bearings 640 and the ball bearing 650 is connected to the shaft 620 via a shaft nut 660 and a screw 670.

The outer ring of the ball bearing 650 is in contact, via a side surface, with a surface 680 of the bearing assembly 600 such that the ball bearing 650 can transmit axial forces via this surface 680 towards the shaft end to the bearing assembly 600 and thus the housing of the compressor. To prevent a transmission of force into the radial-direction housing, the ball bearing 650 is also laterally undercut.

FIG. 5 shows a further exemplary embodiment of a compressor 200 including a rolling-element bearing support 100, which differs from the exemplary embodiment shown in FIG. 2 only in that in this embodiment, not only a single shaft 230 (as in FIG. 2), but rather 2 shafts 230, 230′ are supported via the rolling-element bearing support module 100. For this purpose, in addition to the rolling element bearing assembly 120 already described in the context of FIG. 2, including the first rolling-element bearing 130 and the second rolling-element bearing 140 for the first shaft 230, the rolling-element bearing support module 100 has a second rolling-element bearing assembly 120′, including a corresponding first rolling-element bearing 130′ and a corresponding second rolling-element bearing 140′.

The components of the second rolling-element bearing assembly 120′ correspond to those of the rolling-element bearing assembly 120. Likewise, the constructive embodiments of the shaft 230′ correspond to those of the first shaft 230 with regard to the abutment surface 240′. The first rolling-element bearing 130′ of the second rolling-element bearing assembly 120′ is in contact with the abutment surface 240′ of the shaft 230′, while a side surface of the outer ring of the first rolling-element bearing 130′ transmits axially-occurring forces in the direction of the motor 260′ onto the common end surface 210 of the housing 220. Also, the second rolling-element bearing assembly 120′ again includes a bearing casing 150′, via which the second rolling-element bearing 140′, which is again embodied as a cylindrical roller bearing, transmits radial forces from the second shaft 230′ to the support 110.

As has already been explained at the beginning of the description, it is not necessary to embody the individual bearings identically or in the same manner. Thus, for example, not only can the first or second bearing of the two rolling-element bearing assemblies 120, 120′ be embodied differently, but with regard to the further constructive features they can also be adapted in accordance with the actual conditions. This is indicated in FIG. 5, for example, in the region of the bearing casing 150′, which is shown substantially larger than the bearing casing 150 of the first rolling-element bearing assembly 120. Of course the two rolling-element bearing assemblies 120, 120′ can also differ with regard to other constructive features. Thus it is far from necessary that the alignment of the abutment surfaces 140, 140′ match with respect to the end surface(s) 210 for both rolling-element bearing assemblies 120, 120′. Thus it can be advantageous, for example, if the planes of the abutment surfaces 140, 140′ for a rolling-element bearing assembly coincide with the plane of the end surface 210, while a different, parallel-displaced plane and thus abutment surface is used for the other abutment surface. In other words, it can be advisable to use not only aligned planes, but optionally different, greatly parallel-offset planes for one or more end surfaces 210 and the one or more abutment surfaces 240.

According to an exemplary embodiment of the present invention, both a compressor 200 and a rolling-element bearing support module 100 can have a second rolling-element bearing assembly including a further first rolling-element bearing and a further second rolling-element bearing, which is disposed indirectly or directly adjacent in the axial direction to the first further rolling-element bearing. The second rolling-element bearing assembly is then formed to transmit axial forces, but substantially no radial forces, in at least one axial direction via the first further rolling-element bearing, wherein the second rolling element bearing assembly is further formed to support radial forces via the second further rolling-element bearing, but substantially no axial forces, in the at least one axial direction, and to transmit radial forces to the support. A side surface of the further first rolling-element bearing can thereby be aligned with a plane corresponding to the surface of the machine or the compressor or to a further abutment surface of a further shaft, or can be in contact with this plane, while the first further rolling-element bearing is formed to transmit axial forces in the at least one direction, via the end surface, to a component in a further corresponding plane of the other surface of the end surface and of the further abutment surface of the further shaft, wherein the second further rolling-element bearing is disposed on a side of the first further rolling-element bearing that faces away from the side surface of the first further rolling-element bearing.

FIG. 6 shows a further exemplary embodiment of a rolling-element bearing support module 100, which is very similar to the one from FIG. 1. Thus the rolling-element bearing support module 100 also has a support 110 and rolling-element bearing assembly 120 including a first rolling-element bearing 130, a second rolling-element bearing 140, and a bearing casing 150, as has already been described in more detail in the context of FIG. 1.

However, the rolling-element bearing support module 100 from FIG. 6 differs from the one from FIG. 1 with regard to two aspects. Thus the rolling-element bearing support module 100 from FIG. 6 includes a further angular contact ball bearing 700, which is disposed between the first rolling-element bearing 130 and the second rolling-element bearing 140. In this case the first and the second rolling-element bearing 130, 140 are thus no longer directly, but rather indirectly, adjacent via the further angular contact ball bearing 700. In further exemplary embodiments of a rolling-element bearing support module 100, this further angular contact ball bearing 700 can also be replaced by another radial bearing, i.e. for example a ball bearing, a four-point angular contact ball bearing, a shoulder ball bearing, a self-aligning ball bearing, or another rolling-element bearing. Instead of a single bearing, it is also possible to use more than one rolling-element bearing, optionally of different types, at this location. It is also possible to use, for example, a second cylindrical roller bearing or a different rolling-element bearing instead of the further angular contact ball bearing 700, which is formed substantially to transmit forces to the support 110 in the axial direction via a bearing casing or another mechanically stable connection.

Moreover, the rolling-element bearing support module 100 shown in FIG. 6 further differs from the one shown in FIG. 1 in that it includes a further rolling-element bearing assembly 710 having a third rolling-element bearing 720, wherein the further rolling-element bearing assembly 710 is formed to support axial forces in the other axial direction, i.e. in the opposite direction, and to transmit the axial forces to the support 110. In the exemplary embodiment shown in FIG. 6, the third rolling-element bearing 720 is an angular contact ball bearing, which is installed in a mirror-symmetric manner to the first rolling-element bearing 130 such that a side surface thereof is in contact with the support 110. If an axial force is now applied to the right from a shaft not shown in FIG. 6 via the inner ring of the third rolling-element bearing 720, it is transmitted directly to the support 110 via the high shoulders of the inner and outer rings of the third rolling-element bearing, which are disposed in mirror-image manner.

By using a further rolling-element bearing assembly 710 having the third rolling-element bearing 720, it is thus also possible to implement a locating/non-locating bearing using exemplary embodiments of the present invention, while the previously-disclosed rolling-element bearing support modules were designed for a floating bearing or optionally a pretensioned installation with a correspondingly mirrored second bearing on the other end of the shaft.

Of course, the further rolling-element bearing assembly can be supplemented by a fourth rolling-element bearing 730, which, similar to the second rolling-element bearing 140, is formed to substantially transmit radial forces to the support 110, but not axial forces. Thus for example the third rolling-element bearing 720 can be supplemented with a cylindrical roller bearing as a fourth rolling-element bearing 730 such that it directly or even indirectly connects to the third rolling-element bearing. A free region is thereby formed between the further rolling-element bearing assembly 710 and the rolling-element bearing assembly 120 such that at least one side surface of the further rolling-element bearing lies two. This side surface of the rolling-element bearing assembly opposes the side surface of the further rolling-element bearing assembly 710, which is in contact with the support 110 or applies forces thereto.

FIG. 7 shows a further compressor 200 according to an exemplary embodiment of the present invention, which differs from the compressor shown in FIG. 2 only in that no rolling-element bearing support module 100 is used in the compressor shown in FIG. 7, but rather the first and second rolling-element bearings 130, 140 are inserted directly into a corresponding bore in the housing 220 of the compressor 200. Consequently, the end surface 210 results in the region of the bore, into which the rolling-element bearing assembly 120 is inserted. With an exemplary embodiment of the compressor 200 shown in FIG. 7, the corresponding bore 800 can thus be sealed by a cover 810 after the assembly of the rolling-element bearing assembly 120.

Moreover, the abutment surface of the shaft can be formed not only by a shaft shoulder, as has previously been described in the present application, but also formed by other methods. It is possible for example to create an appropriate abutment surface by introducing a collar or another projection having defined geometry.

Since the exemplary embodiments of the compressors 200 from the FIGS. 2 and 7 do not differ, reference is made to the description of the compressor 200 above.

Exemplary embodiments of the present invention are not limited only to compressors and screw compressors, but are also usable in many locations on other machines, for which axial bearings and corresponding abutment surfaces are to be positioned as exactly as possible. Besides machines in the compressor field and in the field of pumping other liquids and gases, exemplary embodiments of the present invention can therefore be used in other fields of mechanical engineering.

### REFERENCE NUMBER LIST

100 Rolling-element bearing support module
110 Support
120 Rolling-element bearing assembly
130 First rolling-element bearing
130a Inner ring
130b Rolling-element
130c Outer ring
140 Second rolling-element bearing
140a Inner ring
140b Rolling element
140c Outer ring
150 Bearing casing
160 Symmetry line
170 Clearance
180 Plane
200 Compressor
210 End surface
220 Housing
230 Shaft
240 Abutment surface
250 Counterbore
260 Rotor
270 Bore
280 Rotor end surface
290 Housing end surface
300 End gap
310 Tolerance chain
320 Ring
400 Compressor
410 Screw shaft
420 Screw shaft
430 Housing
440 Non-locating bearing
450 Locating bearing assembly
460 Intermediate ring
470 Cylindrical roller bearing
480 Four-point angular contact ball bearing
490 Non-locating bearing
500 Locating bearing assembly
510 Intermediate ring
520 Cylindrical roller bearing
530 Four-point angular contact ball bearing
600 Bearing assembly
610 Intermediate ring
620 Shaft
630 Cylindrical roller bearing
640 Angular contact ball bearing
650 Ball bearing
660 Shaft nut
670 Screw
680 Surface
700 Further angular contact ball bearing
710 Further rolling-element bearing assembly
720 Third rolling-element bearing
730 Fourth rolling-element bearing
800 Bore
810 Cover

1. A machine, comprising:
an end surface with a bore, and a shaft having an abutment surface extending in a radial direction, wherein the shaft at least partially extends into the bore in an axial direction, wherein the end surface and the abutment surface extend substantially parallel to each other; and
a rolling-element bearing support module comprising:
a support; and
a rolling-element bearing assembly including a first rolling-element bearing and a second rolling-element bearing, the second rolling-element bearing being disposed indirectly or directly adjacent to the first rolling-element bearing in the axial direction,
wherein the rolling-element bearing assembly is formed to transmit, via the first rolling-element bearing, axial forces in at least one axial direction, but substantially no radial forces;
wherein the rolling-element bearing assembly is further formed to support, and transmit to the support via the second rolling-element bearing, radial forces, but substantially no axial forces in the at least one axial direction;
wherein a side surface of the first rolling-element bearing is aligned with a plane corresponding to the end surface of the machine or the abutment surface of the shaft;
wherein the first rolling-element bearing is formed to transmit, via the side surface, the axial forces in the at least one direction to a component in a corresponding plane of the other surface of the end surface and of the abutment surface of the shaft; and
wherein the second rolling-element bearing is disposed on a side of the first rolling-element bearing that faces away from the side surface of the first rolling-element bearing.

2. The machine according to claim 1, wherein the first rolling-element bearing is an angular contact ball bearing.

3. The machine according to claim 2, wherein the first rolling-element bearing has a width tolerance of the class P4A or PA 7 or finer.

4. The machine according to claim 1, wherein the rolling-element bearing support module has at least one clearance which connects to the first rolling-element bearing in the radial direction, so that at least 80% of a circumferential surface of an outer ring of the first rolling-element bearing is exposed.

5. The machine according to claim 1, wherein, the second rolling-element bearing is a cylindrical roller bearing.

6. The machine according to claim 1, wherein the rolling-element bearing assembly includes a further angular contact ball bearing or radial bearing, which is preferably disposed between the first and the second rolling-element bearing.

7. The machine according to claim 1, which further includes a further rolling-element bearing assembly which comprises a third rolling-element bearing, wherein the further rolling-element bearing assembly is formed to support, and apply to the support via a first side surface of the further rolling-element bearing assembly, axial forces in one of the at least one directions opposing an axial direction, wherein a second side surface of the further rolling-element bearing assembly is exposed, wherein the second side surface of the further rolling-element bearing assembly opposes the first side surface of the further rolling-element bearing assembly and the side surface of the rolling element bearing assembly, and wherein the further rolling-element bearing assembly is disposed indirectly or directly adjacent to the rolling element bearing in the axial direction based on a centerline of the first rolling-element bearing.

8. The machine according to claim 1, wherein the support is formed to be connectable in a friction-fit or materially-bonded manner to a housing of the machine.

9. The machine according to claim 1, wherein the machine is a compressor, preferably a screw compressor.

10. A compressor comprising:
a first component having a bore in an end surface of the first component;
a shaft, which extends into the bore substantially in an axial direction parallel to the bore, and has an abutment surface, which extends substantially in a radial direction and substantially in parallel to the end surface;
a rolling-element bearing assembly including a first rolling-element bearing and a second rolling-element bearing, the second rolling-element bearing being disposed indirectly or directly adjacent to the first rolling-element bearing in the axial direction,
wherein the rolling-element bearing assembly is formed to support, via the first rolling-element bearing, axial forces in at least one axial direction, but substantially no radial forces;
wherein the rolling-element bearing assembly is further formed to support, and transmit to the first component via the second rolling-element bearing, radial forces, but substantially no axial forces in the at least one axial direction;
wherein a side surface of the first rolling-element bearing is in contact with the end surface or the abutment surface of the shaft;
wherein the first rolling-element bearing is formed to transmit, via the side surface, the axial forces in the at least one direction to the other surface of the end surface and of the abutment surface of the shaft; and
wherein the second rolling-element bearing is disposed on a side of the first rolling-element bearing that faces away from the side surface of the first rolling-element bearing.

11. The machine according to claim 1, wherein the first rolling-element bearing is an angular contact ball bearing and the second rolling-element bearing is a cylindrical roller bearing.

12. The machine according to claim 11, wherein the rolling-element bearing support module has at least one clearance which connects to the first rolling-element bearing in the radial direction, so that at least 80% of a circumferential surface of an outer ring of the first rolling-element bearing is exposed.

13. The machine according to claim 12, further including a further rolling-element bearing assembly which comprises a third rolling-element bearing, wherein the further rolling-element bearing assembly is formed to support, and apply to the support via a first side surface of the further rolling-element bearing assembly, axial forces in one of the at least one directions opposing an axial direction, wherein a second side surface of the further rolling-element bearing assembly is exposed, wherein the second side surface of the further rolling-element bearing assembly opposes the first side surface of the further rolling-element bearing assembly and the side surface of the rolling element bearing assembly, and wherein the further rolling-element bearing assembly is disposed indirectly or directly adjacent to the rolling element bearing in the axial direction based on a centerline of the first rolling-element bearing.

14. A machine, comprising:
an end surface;
a bore in the end surface;
a shaft having a longitudinal axis and a radially extending abutment surface, the shaft at least partially extending in the bore such that the end surface and the abutment surface are substantially parallel to each other; and
a rolling-element bearing support module comprising:
a support; and
a rolling-element bearing assembly in the support and including a first rolling-element bearing and a second rolling-element bearing, the second rolling-element bearing being disposed adjacent to the first rolling-element bearing in the axial direction,
wherein the rolling-element bearing assembly is configured such that the first rolling-element bearing transmits axial movements of the shaft in a first direction to the end surface but does not transmit radial movements of the shaft to the support and such that the second rolling element bearing transmits radial movements of the shaft to the support but does not transmit axial movements of the shaft in the first direction to the end surface,
wherein a first side surface of the first rolling-element bearing is aligned with a plane corresponding to a first one of the end surface of the machine and the abutment surface of the shaft;
wherein the first rolling-element bearing is formed to transmit, via the first side surface, the axial movement of the shaft in the first direction to a component in a corresponding plane of a second one of the end surface of machine and the abutment surface; and
wherein the second rolling-element bearing is disposed at a second side surface of the first rolling-element bearing opposite the first side surface.

15. The machine according to claim 14, wherein the first rolling-element bearing is an angular contact ball bearing and the second rolling-element bearing is a cylindrical roller bearing.

16. The machine according to claim 14, including at least one radial gap between the first rolling-element bearing and the support.

17. The machine according to claim 16, wherein at least 80% of a circumferential surface of an outer ring of the first rolling-element bearing is exposed.
